(19) United States
(12) Patent Application Publication
(10) Pub. No.: US 2014/0111375 A1
(43) Pub. Date: Apr. 24, 2014

(54) GNSS FINE-TIME ASSISTANCE OVER RTT-CAPABLE WIRELESS NETWORKS

(71) Applicant: QUALCOMM INCORPORATED, San Diego, CA (US)

(72) Inventor: Stephen Joseph BEAUREGARD, Santa Calra, CA (US)

(73) Assignee: QUALCOMM INCORPORATED, San Diego, CA (US)

(21) Appl. No.: 13/656,402

(22) Filed: Oct. 19, 2012

(51) Int. Cl. G01S 19/05

(52) U.S. Cl. CPC G01S 19/05
USPC 342/357.42

(57) ABSTRACT

Systems and methods of providing fine-time assistance (FTA) for a mobile device are described herein. A GNSS time is received from a GNSS satellite at a GNSS receiver. The GNSS time is then transferred to an access point (AP) over a wired network. The AP is coupled to the mobile device over a wireless local area network (WLAN). A round trip time (RTT) between the AP and the mobile device over the WLAN is determined, for example by exchanging one or more communications between the mobile device and the AP over the wireless local area network (WLAN). The GNSS time is then transferred from the AP to the mobile device over the WLAN. A FTA based GNSS time is calculated at the mobile device based on the GNSS time received from the AP and the RTT.

### FIELD OF DISCLOSURE

Disclosed embodiments are directed to position estimation. More particularly, exemplary embodiments are directed to providing fine-time assistance to mobile devices over wireless local area networks, for example to improve tracking accuracy in indoor environments or to improve a time to first fix when departing a GNSS denied area.

### BACKGROUND

Global navigation satellite systems (GNSS) are well known in applications concerning tracking and positioning. GNSS systems such as the global positioning system (GPS) are satellite-based systems used for pinpointing a precise location of a mobile device, GNSS receiver, or object capable of tracking satellite signals. With advances in GNSS technology, it is possible to accurately locate and track real-time movements of an object anywhere on the globe.

GNSS systems operate by configuring a GNSS satellite to transmit certain signals which may include pre-established codes. These signals may be based on an atomic clock present in the satellite. The transmitted signals may include a time stamp indicating the time at which they were transmitted. A GNSS receiver, which may be integrated in a mobile device, is timed by a local clock located at the receiver end. Ideally, this local clock is synchronized to the satellite clock (also known as the GNSS time). GNSS receivers are configured to estimate the GNSS time based on the satellite signals in order to synchronize their local clocks to the GNSS time. Once the local clocks are accurately synchronized, the GNSS receiver is configured to calculate the propagation time for the satellite signals to reach the receiver, based on a difference between the time at which the signals were received, and the time at which they were transmitted. This propagation time is an indication of the distance between the satellite and the GNSS receiver, keeping in mind that factors such as atmospheric conditions may affect the propagation time.

In order to pinpoint the location of the GNSS receiver, the GNSS receivers perform the above process to calculate the distance to at least two other satellites. Using the distance to three satellites, it is theoretically possible to accurately trilaterate the position of the GNSS receiver, as there can be only one unique point of intersection of these distances. However, in practice, one or more additional satellites may be required in order to compensate for inherent inaccuracies. One source of inaccuracy is introduced by the difficulty of achieving fine-grained synchronization of the local clock at the GNSS receiver and the satellite clocks in order to provide an accurate estimate of the GNSS time at the GNSS receiver. Even minor offsets in the GNSS time estimate at the GNSS receiver may greatly affect the accuracy of the tracking in GNSS systems. Accordingly, there is a well-recognized need for maintaining a very high precision synchronization between the satellite clocks and the GNSS receiver.

### SUMMARY

Exemplary embodiments of the invention are directed to systems and methods for providing fine-time assistance (FTA) to a mobile device.

Accordingly, an exemplary embodiment is directed to a method of providing fine-time assistance (FTA) for a mobile device, the method comprising: receiving a first GNSS time at an access point (AP) over a wired network from a first GNSS receiver, determining a round trip time (RTT) between the AP and the mobile device over a wireless local area network (WLAN), and transmitting the first GNSS time from the AP to the mobile device over the WLAN for calculating a FTA based GNSS time at the mobile device based on the first GNSS time from the AP and the RTT.

Another exemplary embodiment is directed to an apparatus for fine-time assistance (FTA) comprising: a receiver configured to receive a GNSS time over a wired network from a GNSS receiver, logic configured to determine a round trip time (RTT) from an access point (AP) to a mobile device over a wireless local area network (WLAN), and a transmitter configured to transmit the GNSS time to the mobile device over the WLAN to calculate a FTA based GNSS time at the mobile device based on the GNSS time and the RTT.

Another exemplary embodiment is directed to a system comprising: means for receiving a GNSS time over a wired network from a GNSS receiver, means for determining a round trip time (RTT) to a mobile device over a wireless local area network (WLAN), and means for transmitting over the WLAN the GNSS time to the mobile device for calculating a fine-time assistance (FTA) based GNSS time at the mobile device based on the transmitted GNSS time and the RTT.

Another exemplary embodiment is directed to a non-transitory computer-readable storage medium comprising code, which, when executed by a processor, causes the processor to perform operations for providing fine-time assistance (FTA) for a mobile device, the non-transitory computer-readable storage medium comprising: code for receiving a GNSS time over a wired network from a GNSS receiver, code for determining a round trip time (RTT) to the mobile device over a wireless local area network (WLAN), and code for transmitting over the WLAN the GNSS time to the mobile device for calculating a FTA based GNSS time at the mobile device based on the transmitted GNSS time and the RTT.

Another exemplary embodiment is directed to a method of receiving fine-time assistance (FTA) at a mobile device, the method comprising: determining a round trip time (RTT) between the mobile device and an access point (AP) over a wireless local area network (WLAN), receiving a GNSS time from the AP over the WLAN, and calculating a FTA based GNSS time at the mobile device based on the GNSS time from the AP and the RTT.

Another exemplary embodiment is directed to an apparatus for fine-time assistance (FTA) comprising: logic configured to determine a round trip time (RTT) between a mobile device and an access point (AP) over a wireless local area network (WLAN), a receiver configured to receive a GNSS time from the AP over the WLAN, and logic configured to calculate a FTA based GNSS time at the mobile device based on the GNSS time from the AP and the RTT.

Another exemplary embodiment is directed to a system comprising: means for determining a round trip time (RTT) between a mobile device and an access point (AP) over a wireless local area network (WLAN), means for receiving a GNSS time from the AP over the WLAN, and means for calculating a fine-time assistance (FTA) based GNSS time based on the GNSS time from the AP and the RTT.

Another exemplary embodiment is directed to a non-transitory computer-readable storage medium comprising code, which, when executed by a processor, causes the processor to perform operations for providing fine-time assistance for a mobile device, the non-transitory computer-readable storage medium comprising: code for determining a round trip time (RTT) between the mobile device and an access point (AP) over a wireless local area network (WLAN), code for receiving a GNSS time from the AP over the WLAN, and code for calculating a fine-time assistance (FTA) based GNSS time based on the GNSS time from the AP and the RTT.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates an exemplary GNSS system for providing fine-time assistance (FTA) to a mobile device.

FIG. 2A is a flow-chart depiction of a method of providing FTA to a mobile device, the method performed at an access point, according to exemplary embodiments.

FIG. 2B is a flow-chart depiction of a method of receiving FTA at a mobile device, the method performed at the mobile device, according to exemplary embodiments.

FIG. 3 illustrates a block diagram of a particular illustrative embodiment of a mobile device, according to exemplary embodiments.

FIG. 4 illustrates a block diagram of a particular illustrative embodiment of an access point, according to exemplary embodiments.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

As previously described, it may be beneficial to maintain a high precision synchronization between the satellite clocks and mobile devices, which may include GNSS receivers, in indoor environments and/or GNSS-denied areas where the strength of the satellite signals is weak. Using conventional techniques, the accuracy of GNSS tracking is severely reduced when approaching or leaving GNSS-denied areas. In particular, when leaving a GNSS-denied area (e.g., a building in some circumstances), conventional GNSS receivers are not well suited to accurately synchronize their local clock to the satellite clocks. In some situations, satellite signals may be partially blocked. For example, some buildings have roof structures and window layouts that may partially block GNSS signals. As a consequence, a larger number of satellites may be required in order to improve accuracy of tracking, but it may not always be possible to acquire satellite signals to such larger numbers of satellites. As a result, conventional GNSS receivers may not be capable of accurately estimating the distance to satellites based on these weak signals and performing a trilateration process with high accuracy.

In order to overcome the above deficiencies, exemplary embodiments are directed to providing GNSS fine-time assistance (FTA) to GNSS receivers in order to improve synchronization of a local clock at the GNSS receiver with GNSS satellite clocks. More particularly, some embodiments relate to providing FTA to GNSS receivers located in GNSS-denied areas over wireless local area networks (WLANs). It will be understood that embodiments are not restricted to GNSS-denied areas, but may be easily extended to situations which relate to providing FTA to GNSS receivers or reducing the time to first fix when leaving a GNSS denied area, or when a reduction of power in acquisition/reacquisition of signals is desired. For example, in some embodiments it may be more power efficient for a mobile device or other receiver to obtain FTA over a WiFi connection according to some implementations rather than synchronizing a local clock of the mobile device with GNSS time using satellite signals. A detailed description of embodiments will now be provided with reference to non-limiting exemplary scenarios where embodiments may be applicable.

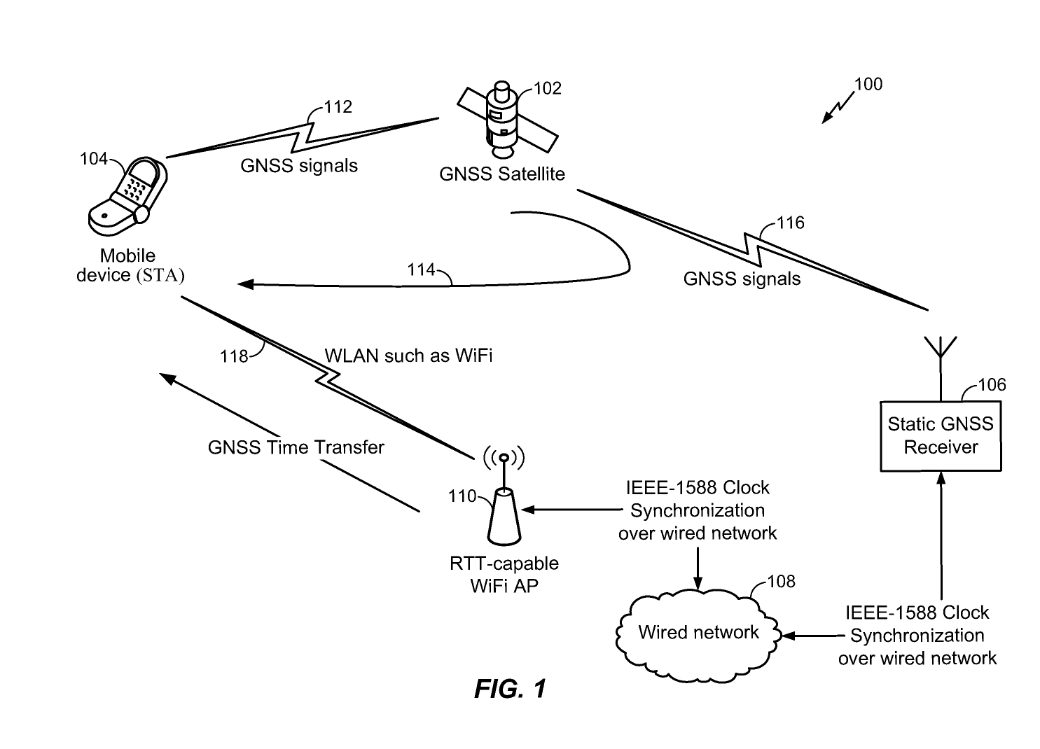

With reference now to FIG. 1, GNSS system 100 configured for providing FTA to GNSS receivers according to exemplary embodiments is illustrated. GNSS satellite 102 may include a high precision atomic clock (not shown) synchronized to GNSS time. Mobile device or station (STA) 104 may be integrated with a GNSS receiver. Embodiments relate to high precision transfer of GNSS time to STA 104. Path 112 illustrates a direct transfer of satellite signals from GNSS satellite 102 to STA 104. In situations where path 112 may support strong signal strength, GNSS time may be directly transferred from GNSS satellite 102 to STA 104 over path 112. However, path 112 may not always be available. For example, when STA 104 is located in a GNSS-denied area such as inside a building, path 112 may be non-existent or incapable of meeting minimum signal strength requirements. In such situations concerning non-availability, or insufficient availability of path 112, exemplary embodiments provide path 114, which will now be described in detail.

In general, path 114 may include a backend network configured to receive GNSS time at a high precision. Path 114 may further include a wireless LAN to transfer the received GNSS time to STA 104 without loss of precision, thus completing the path for providing FTA to STA 104. In order to receive an accurate GNSS time, path 114 may include a receiver located in a position that is known to have a strong signal to GNSS satellite 102. In some embodiments, this receiver with a strong signal may be stationary or static. As used herein, the term “static receiver” may correspond to a receiver configured to receive satellite signals, wherein the position of the receiver is known or wherein the receiver is known to have a clear view or unobstructed path to a satellite signal or to receive a threshold number of satellite signals and/or satellite signals having a quality metric above a certain level, for example. It will be understood that embodiments are not restricted to an immobile receiver for the described functionality, and skilled persons will recognize suitable implementations of embodiments wherein the static receiver are mobile or semi-mobile without departing from the scope of this disclosure.

In the illustrated embodiment, path 114 may include a static GNSS receiver 106, situated at a location that is known to have a strong signal path 116 to GNSS satellite 102, for example, at a location with a clear view of the sky. As previously described, in some embodiments, static GNSS receiver may be mobile or semi-mobile or otherwise not stationary. Regardless of the specific implementation of static GNSS receiver 106, GNSS time may be transferred to static GNSS receiver 106 over path 116. Static GNSS receiver 106 may be coupled to access point (AP) 110 through a wired network 108. Wired network 108 may be, for example, an Ethernet network, and capable of supporting high precision clock synchronization using any suitable version of the IEEE 1588 standard for precision clock synchronization or any other suitable precision time protocol (PTP). In some embodiments, wired network 108 may include a powerline communication (PLC) network, instead of an Ethernet network running over CAT5 or coaxial cables, wherein the PLC network may be configured, for example, according to the IEEE 1901 standard.

Regardless of particular implementations which may be chosen, wireless network 108, in exemplary embodiments, may be configured to transfer GNSS time to AP 110 using a selected clock synchronization protocol. In this embodiment, static GNSS receiver 106 may comprise a master clock which drives a slave clock located at AP 110. Without departing from the scope of this disclosure, alternative embodiments may combine static GNSS receiver 106 and AP 110 at the same location or device, and thus avoid wired network 108.

Regardless of whether AP 110 receives GNSS time through wired network 108 as illustrated or wirelessly/directly from GNSS satellite 102, by being situated at a same location/device as static GNSS receiver 106, this received GNSS time may now be transferred to STA 104 in the following manner.

Both STA 104 and AP 110 may be configured to communicate over a WLAN such as a WiFi network, for example, along path 118. Further, STA 104 and AP 110 may be configured to exchange one or more communications, such as a bidirectional message, in order to determine a round-trip time (RTT) between STA 104 and AP 110 along path 118. The bidirectional message exchange may once again be based on standard protocols such as PTP or IEEE 1588. Once the RTT between STA 104 and AP 110 is known, the GNSS time may be transferred over the WLAN from AP 110 to STA 104 and the RTT may be factored in at STA 104 in order to derive a precise GNSS time. Once again, this transfer from AP 110 to STA 104 may be compatible with any suitable version of the IEEE 1588 standard for precision clock synchronization. In one example of factoring in the RTT, a one-way transfer time for a signal to traverse from AP 110 to STA 104 along path 118 may be calculated from the RTT by accounting for any delays introduced by AP 110 itself. By adding the one-way transfer time to the GNSS time received at STA 104, the GNSS time received at STA 104 can be calculated. In some embodiments, the AP 110 determines the one-way transfer time and adds it to the GNSS time before transmitting the GNSS time to the STA 104 such that the correct GNSS time is received at the STA 104. Accordingly, such embodiments can comprise adjusting the GNSS time based, at least in part, on the RTT prior to transmitting the first GNSS time from AP 110 to STA 104. In other embodiments, the STA 104 is aware of the one-way transfer time, for example based due to receiving the one-way transfer time from the AP 110 or calculating the one-way transfer time at the STA 104, and may add the one-way transfer time to an unadjusted GNSS time received from the AP 110 in order to determine the correct GNSS time.

The GNSS time so received at STA 104 can also be referred to as the transferred GNSS time. By using the transferred GNSS time, a very precise value of GNSS time may be realized at STA 104, even in situations where STA 104 may not have a clear path 112 to GNSS satellite 102. The accuracy of providing FTA to STA 104 may be as accurate as the RTT timing resolution (which may be, for example, in the range of tens of nanoseconds or less). Accordingly, in some embodiments, the accuracy of GNSS time received at STA 104 may be in the range of one microsecond or less, for example, in the range of 100s of nanoseconds. It will be recognized that in some embodiments, such high accuracy of GNSS time may enable highly accurate tracking of mobile devices, such as STA 104, for example, within the order of one or two meters or less. Thus, embodiments herein may be implemented to provide not only more accurate time to the STA 104, but also greater precision in positioning.

Accordingly, in the above-described embodiments, accurate GNSS time transfer over a WiFi network to a STA located in a building may enable “pseudo range” measurements where insufficient signal strength or an insufficient number of satellite signals may be directly obtained at exemplary STAs to otherwise determine a GNSS time or where such signals may otherwise be slowly obtained. A pseudo range measurement, for example, may refer to measurement of distance to a GNSS satellite for tracking purposes, but here uses the transferred GNSS time, instead of an originally received GNSS time, for example at static GNSS receiver 106. As will be recalled from the previous discussion, propagation time of satellite signals to GNSS receivers may provide an indication of the distance or range to the GNSS satellite. The propagation time may be determined based on the GNSS time when known at the STA in some embodiments. Accordingly, using FTA to provide accurate GNSS time at the STAs may improve acquisition/reacquisition of pre-established codes, such as Y-codes from GNSS satellites, because these codes are based on the atomic clock in some embodiments (and may be based on another clock in other embodiments), which can now be accurately transferred to the STAs. Moreover, in some exemplary embodiments, pseudo ranges to two or more satellites (e.g. a second and a third satellite, in addition to GNSS satellite 102), may be obtained in similar manner as described for obtaining pseudo range measurements to GNSS satellite 102, for example based on the accurate GNSS time. Thereby, using pseudo range measurements to at least three satellites can enable trilateration for positioning STA 104. In some cases, embodiments herein allow for a location of a mobile station to be determined using signals from a reduced number of satellites. For example, in some circumstances, signals from four satellites are used to resolve GNSS time and determine a location of a mobile device. According to embodiments described herein, however, the location of the mobile device may be determined using signals from three satellites in some such circumstances, for example because the GNSS time may be obtained from a source, e.g., from an AP over a WLAN, other than directly from the satellites.

Accordingly, in exemplary embodiments, any unknown clock offset that may exist at STA 104 relative to GNSS time may be eliminated using the transferred GNSS time from AP 110. The clock at STA 104 may thus be synchronized to GNSS time prior to commencement of operations pertaining to reception and decoding of GNSS messages/signals. As previously described, the signals transmitted from the GNSS satellites may include a transmission time stamp at which they were transmitted. Once the clock at STA 104 is synchronized to GNSS time, STA 104 can then calculate the time of flight from the GNSS satellite to STA 104 by subtracting the transmission time stamp included in a received GNSS signal from the current GNSS time. In other embodiments, an expected code or signal may be compared to a received code or signal to determine timing and/or phase offsets, or timing and/or phase offsets may be determined in another way. In some embodiments, STA 104 may begin correlating signals and/or otherwise determining its position as soon as any satellite signals are received, and thus may omit waiting for all satellite signals to be received, for example in order to resolve GNSS time. Such operation may decrease a time used to acquire a location, for example a time to first fix (TTFF). Thus, certain embodiments described herein may be quicker, may be more accurate, and/or may consume less power than certain other methods known in the art.

Accordingly, GNSS tracking or position determination may be conducted with a high degree of accuracy by using one or more GNSS ranges (e.g. pseudo range) in GNSS-denied areas or areas partially masked from GNSS signals (e.g. in the immediate vicinity of buildings where a full complement of GNSS satellites may not be available). In some embodiments, exemplary STAs may only need to be within WiFi reception range of at least one AP. Moreover, exemplary FTA techniques may also enable uninterrupted GNSS tracking or position determination operations in indoor environments where GNSS signal strengths may be severely downgraded.

Thus, the GNSS time information received over WLANs like WiFi may be used in combination with signals from one or more positioning systems, such as satellite signals in GNSS/GPS systems, in order to track a STA. Utilizing the GNSS time information may allow the STA to determine position information with a greater accuracy, using a fewer number of signals/devices from the positioning system, and using weaker signals. For example, the STA may obtain time information from an AP over WiFi, and then use the GNSS time information in combination with signals from three satellites instead of four to obtain the position of the STA. This may reduce the amount of power used to determine a position, as well as reduce the time to first fix (TTFF) of the position.

Further, as seen from the above disclosure, exemplary embodiments described herein may provide one or more advantages over other techniques. For example, some techniques may include GNSS timestamps in WiFi frames transferred to mobile devices in order to determine a range. However, such techniques generally require the mobile device to have a high degree of synchronization to an absolute or GNSS time in advance, and generally do not actually transfer time. Rather, the time known in advance is generally utilized to calculate the range. In contrast to certain embodiments described herein, such techniques are generally inadequate in providing time, for example fine time by way of FTA, to GNSS receivers, or in resolving delays in TTFF as described herein. In circumstances where time is not known in advance to a device, some other techniques attempt to transfer time to devices over wired networks, and accordingly these conventional techniques are severely limited in requiring the devices to be connected to a wired network. Certain embodiments described herein, however, are capable of providing fine time and/or FTA to mobile devices, for example by efficiently determining a RTT between the mobile devices and an AP, and transferring GNSS time over WiFi.

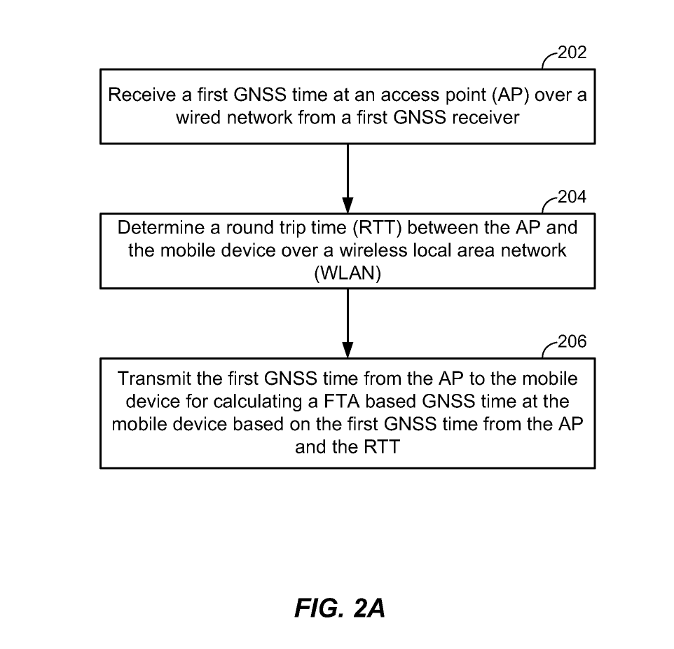

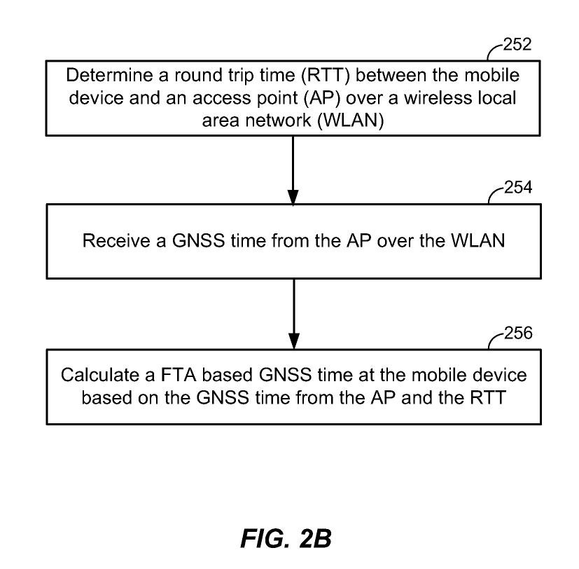

It will be appreciated that embodiments include various methods for performing the processes, functions and/or algorithms disclosed herein. For example, as illustrated in FIG. 2A, an embodiment can include a method of providing fine-time assistance (FTA) for a mobile device (e.g. STA 104), the method comprising: receiving a first GNSS time at an access point (AP) (e.g. AP 110) over a wired network (e.g. wired network 108) from a first GNSS receiver (e.g. static GNSS receiver 106)—Block 202; determining a round trip time (RTT) between the AP and the mobile device (e.g. by exchanging one or more communications or by accessing a known or previously determined and/or stored RTT) over a wireless local area network (WLAN) (e.g. WLAN 118)—Block 204; and transmitting the first GNSS time from the AP to the mobile device for calculating a first FTA based GNSS time at the mobile device based on the first GNSS time from the AP and the RTT (e.g. by calculating the one-way transfer time of signals from the AP to the mobile device from the RTT as described above and calculating the FTA based GNSS time using the GNSS time at the AP and the one-way transfer time)—Block 206.

In another example, as illustrated in FIG. 2B, an embodiment can include a method of receiving fine-time assistance (FTA) at a mobile device (e.g. STA 104), the method comprising: determining a round trip time (RTT) between the mobile device and an access point (AP) (e.g. AP 110) over a wireless local area network (WLAN) (e.g. WLAN 118, for example, by exchanging one or more communications between the mobile device and the AP or by accessing a known or previously determined and/or stored RTT)—Block 252; receiving a GNSS time from the AP (e.g. from static GNSS receiver 106 over wired network 108) over the WLAN—Block 254; and calculating a FTA based GNSS time at the mobile device based on the GNSS time from the AP and the RTT (e.g. by calculating the one-way transfer time of signals from the AP to the mobile device from the RTT as described above and calculating the FTA based GNSS time using the GNSS time at the AP and the one-way transfer time)—Block 256. In some embodiments, Block 256 may be omitted from the method described above. For example, as previously discussed, the correct GNSS time may be received at the STA 104 based on the RTT, for example when the AP 110 determines the one-way transfer time and adds it to the GNSS time before transmitting the GNSS time to the STA 104.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

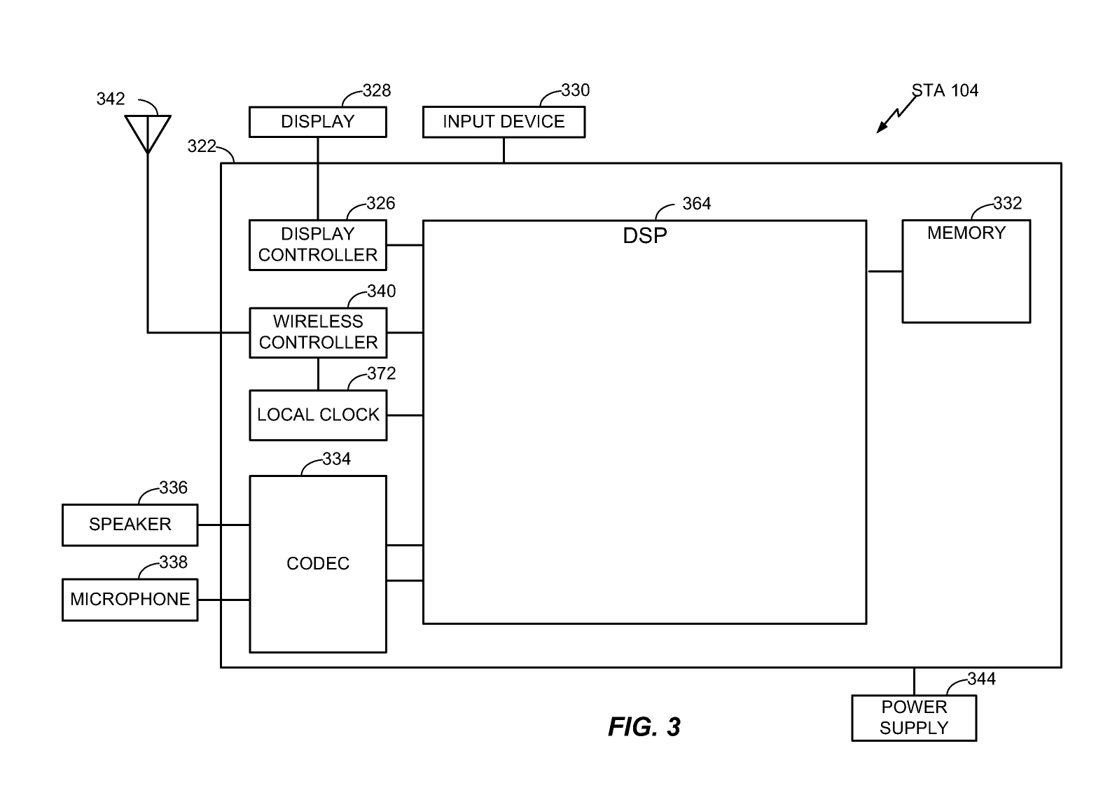

Referring now to FIG. 3, a block diagram of a particular illustrative embodiment of STA 104 is depicted. As illustrated, STA 104 may include a digital signal processor (DSP) 364. DSP 364 may be coupled to memory 332. FIG. 3 also shows display controller 326 that is coupled to DSP 364 and to display 328. Coder/decoder (CODEC) 334 (e.g., an audio and/or voice CODEC) can be coupled to DSP 364. Other components, such as wireless controller 340 (which may include a modem) are also illustrated. Speaker 336 and microphone 338 can be coupled to CODEC 334. FIG. 3 also indicates that wireless controller 340 can be coupled to wireless antenna 342. In a particular embodiment, DSP 364, display controller 326, memory 332, CODEC 334, and wireless controller 340 are included in a system-in-package or system-on-chip device 322.

In a particular embodiment, input device 330 and power supply 344 are coupled to the system-on-chip device 322. Moreover, in a particular embodiment, as illustrated in FIG. 3, display 328, input device 330, speaker 336, microphone 338, wireless antenna 342, and power supply 344 are external to the system-on-chip device 322. However, each of display 328, input device 330, speaker 336, microphone 338, wireless antenna 342, and power supply 344 can be coupled to a component of the system-on-chip device 322, such as an interface or a controller. In one embodiment, one or more of wireless antenna 342, wireless controller 340, and/or DSP 364 may comprise logic or other means for determining a round trip time (RTT) between a mobile device, such as STA 104, and an AP, such as AP 110 (e.g. by exchanging one or more communications with the access point) over a WLAN (e.g. WLAN 118), and/or logic or other means, such as a receiver, for receiving a GNSS time from the AP. Moreover, in some embodiments DSP 364 can include logic or other means for calculating a FTA based GNSS time based on the GNSS time from the AP and the RTT. The receiver may be implemented in a transceiver—thus, the STA 104 may also include a transmitter, for example configured to send one or more messages to an access point in order to determine RTT—and/or in the wireless controller 340 and/or DSP 364 or other element of the STA 104, whether illustrated or not in FIG. 3. In some embodiments, wireless antenna 342, wireless controller 340, DSP 364, memory 332, or any combination thereof, may be configured to perform or to cause a processor or other element associated with the STA 104 to perform any one of Blocks 252, 254, and 256 or any combination thereof.

As illustrated in FIG. 3, STA 104 may also include at least one local clock 372, which may be integrated on a same chip as STA 104 or may be located off chip. The local clock may be synchronized to the FTA based GNSS time received at STA 104 according to exemplary embodiments described above, for example by determining an offset with respect to the local clock 372 and/or configuring a frequency model of an oscillator to account for any difference between the oscillator and the GNSS time. Skilled persons will recognize techniques for calibrating a frequency model of oscillators such as crystal oscillators (XO) and synchronizing the frequency model to a desired frequency, and a detailed explanation of such techniques will not be undertaken here, for the sake of brevity. However, it will be recognized that the local clock 372 may include an oscillator which may be associated with a frequency (or frequency/temperature or FT) curve calibrated and configured to operate at a desired frequency, and the local clock may be synchronized to the FTA based GNSS time. It will be appreciated, however, that signaling between the AP 110 and the STA 104 in some embodiments, does not merely focus or steer a clock frequency, but may be used to transfer a time to the STA 104 in some implementations.

Additionally, in some embodiments, one or more of wireless antenna 342, wireless controller 340, and/or DSP 364 may comprise logicor other means, such as a receiver, for receiving one or more signals from a first satellite, and logic or other means for computing a first pseudo-range measurement or first distance from the mobile device to the first GNSS satellite based at least in part on the FTA based GNSS time and the one or more signals. Further, the above-noted elements may also comprise logic or other means for receiving one or more signals from a second satellite and one or more signals from a third satellite, logic or other means for determining a second and a third pseudo-range measurement from the mobile device to the second and third GNSS satellites based on the FTA based GNSS time and the one or more signals from the second satellite and third satellite, and logic or other means for determining a location of the mobile device based on trilateration of the first, second, and third pseudo-range measurements. In some embodiments, the STA 104 comprises a plurality of antennas 342, wireless controllers 340, DSPs 364, and/or receivers. For example, in some embodiments, the STA 104 comprises separate antennas and/or receivers for receiving signals from a GNSS system or other satellite and for receiving signals over a WLAN.

Accordingly, an embodiment of the invention can include a computer readable media embodying a method for providing fine-time assistance (FTA) for a mobile device in GNSS-denied areas, using GNSS systems. For example, DSP 364 may comprise a computer-readable medium comprising code, which when executed by DSP 364, causes DSP 364 to perform operations for providing fine-time assistance for a mobile device, such as STA 104, in accordance with the embodiment of STA 104 shown and described with regard to FIG. 3. In some embodiments, the computer-readable medium is implemented separate from the DSP 364, for example in the memory 332 or in an external memory or disc. Further, the DSP 364 may comprise one or more components other than a computer-readable medium comprising code, such as hardware components or modules, which cause the DSP 364 to execute such functions or operations. Accordingly, the invention is not limited to illustrated examples and any means for performing the functionality described herein are included in embodiments of the invention. It will be further appreciated that the computer readable media described above may be transitory (e.g. a propagating signal) or non-transitory (e.g. embodied in a register, memory, or hard disk). Non-transitory media may include RAM memory, flash memory, ROM memory, EPROM memory, EEPROM memory, registers, a hard disk, a removable disk, a CD-ROM, or any other form of non-transitory media.

It should be noted that although FIG. 3 depicts a wireless communications device, DSP 364 and memory 332 may also be integrated into a set-top box, a music player, a video player, an entertainment unit, a navigation device, a personal digital assistant (PDA), a fixed location data unit, or a computer. A processor (e.g., DSP 364) may also be integrated into such a device. In some embodiments, STA 104, as depicted in FIG. 3 may be integrated in a semiconductor die.

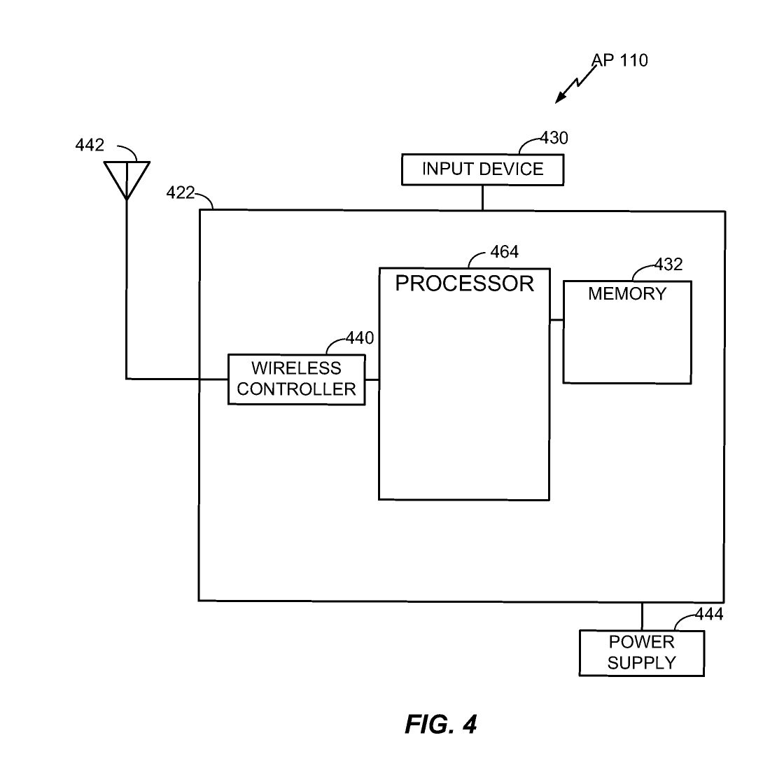

With reference to FIG. 4, a block diagram of a particular illustrative embodiment of AP 110 is depicted. As illustrated, AP 110 may include a processor 464. Processor 464 may be coupled to memory 432. Other components, such as wireless controller 440 (which may include a modem) are also illustrated. FIG. 4 also indicates that wireless controller 440 can be coupled to wireless antenna 442. In a particular embodiment, processor 464, memory 432, and wireless controller 440 are included in a system-in-package or system-on-chip device 422.

In a particular embodiment, input device 430 and power supply 444 are coupled to the system-on-chip device 422. Moreover, in a particular embodiment, as illustrated in FIG. 4, input device 430, wireless antenna 442, and power supply 444 are external to the system-on-chip device 422. However, each of input device 430, wireless antenna 442, and power supply 444 can be coupled to a component of the system-on-chip device 422, such as an interface or a controller. In one embodiment, input device 430 may comprise logic or other means for receiving a GNSS time over a wired network, such as wired network 108, from a first GNSS receiver, such as static GNSS receiver 106. Thus, in one embodiment, input device 430 may be configured as a receiver or transceiver to receive GNSS time over wired network 108. Moreover, in some embodiments, one or more of wireless antenna 442, controller 440, and/or processor 464 can include logic or other means for determining a RTT (e.g. by exchanging one or more communications or by accessing a known or previously determined and/or stored RTT) with a mobile device, such as STA 104, over a wireless local area network (WLAN), and/or logic or other means such as a transmitter for transmitting the GNSS time to the mobile device for calculating a FTA based GNSS time at the mobile device based on the GNSS time from the AP and the RTT. The transmitter may be implemented in a transceiver—thus, the AP 110 may also include a receiver, for example configured to receive one or more messages from a mobile device in order to determine RTT—and/or in the wireless controller 440 and/or processor 464 or other element of the AP 110, whether illustrated or not in FIG. 4. In some embodiments, wireless antenna 442, processor 464, memory 432, or any combination thereof, may be configured to perform or to cause a processor or other element associated with the AP 110 to perform any one of Blocks 202, 204, and 206, or any combination thereof. Moreover, in some embodiments, AP 110 may also include at least one local clock (not shown), configured to synchronize operation of AP 110 and assist in transferring received GNSS time to STA 104.

Accordingly, an embodiment of the invention can include a computer readable media embodying a method for providing fine-time assistance (FTA) for a mobile device in GNSS-denied areas, using GNSS systems. For example, processor 464 may comprise a computer-readable medium comprising code, which when executed by processor 464, causes processor 464 to perform operations for providing fine-time assistance for a mobile device, such as STA 104, in accordance with the embodiment of AP 110 shown and described with regard to FIG. 4. In some embodiments, the computer-readable medium is implemented separate from the processor 464, for example in the memory 432 or in an external memory or disc. Further, the processor 464 may comprise one or more components other than a computer-readable medium comprising code, such as hardware components or modules, which cause the processor 464 to execute such functions or operations. Accordingly, the invention is not limited to illustrated examples and any means for performing the functionality described herein are included in embodiments of the invention. It will be further appreciated that the computer readable media described herein may be transitory (e.g. a propagating signal) or non-transitory (e.g. embodied in a register, memory, or hard disk).

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of providing fine-time assistance (FTA) for a mobile device, the method comprising:
receiving a first GNSS time at an access point (AP) over a wired network from a first GNSS receiver;
determining a round trip time (RTT) between the AP and the mobile device over a wireless local area network (WLAN); and
transmitting the first GNSS time from the AP to the mobile device over the WLAN for calculating a FTA based GNSS time at the mobile device based on the first GNSS time from the AP and the RTT.

2. The method of claim 1, wherein the receiving is performed using an IEEE 1588 synchronization protocol or a precision time protocol (PTP).

3. The method of claim 1, wherein the wired network comprises a powerline communication (PLC) network configured according to IEEE 1901 standard.

4. The method of claim 1, wherein the first GNSS receiver has a clear view or unobstructed path to a first GNSS satellite.

5. The method of claim 1, wherein the WLAN is a WiFi network.

6. The method of claim 1, wherein the FTA based GNSS time is used to compute a first pseudo-range measurement or first distance from the mobile device to a first GNSS satellite, the first GNSS time being from the first GNSS satellite.

7. The method of claim 1, further comprising adjusting the first GNSS time based, at least in part, on the RTT prior to transmitting the first GNSS time from the AP to the mobile device.

8. The method of claim 1, wherein the FTA based GNSS time is accurate to 1 microsecond or less.

9. The method of claim 1, wherein the FTA based GNSS time is accurate to 100 nanoseconds or less.

10. The method of claim 1, wherein the determining comprises exchanging one or more communications with the mobile device, and wherein the exchanging is performed using an IEEE 1588 synchronization protocol or a precision time protocol (PTP).

11. An apparatus for fine-time assistance (FTA) comprising:
a receiver configured to receive a GNSS time over a wired network from a GNSS receiver;
logic configured to determine a round trip time (RTT) from an access point (AP) to a mobile device over a wireless local area network (WLAN); and
a transmitter configured to transmit the GNSS time to the mobile device over the WLAN to calculate a FTA based GNSS time at the mobile device based on the GNSS time and the RTT.

12. The apparatus of claim 11 integrated in an access point (AP).

13. The apparatus of claim 11, wherein the wired network is configured according to an IEEE 1588 synchronization protocol or a precision time protocol (PTP).

14. The apparatus of claim 11, wherein the wired network comprises a powerline communication (PLC) network configured according to IEEE 1901 standard.

15. The apparatus of claim 11, wherein the WLAN is a WiFi network.

16. The apparatus of claim 11 integrated in at least one semiconductor die.

17. A system comprising:
means for receiving a GNSS time over a wired network from a GNSS receiver;
means for determining a round trip time (RTT) to a mobile device over a wireless local area network (WLAN); and
means for transmitting over the WLAN the GNSS time to the mobile device for calculating a fine-time assistance (FTA) based GNSS time at the mobile device based on the transmitted GNSS time and the RTT.

18. The system of claim 17, wherein the GNSS receiver has a clear view or unobstructed path to a first GNSS satellite.

19. The system of claim 17, wherein the receiving is performed using an IEEE 1588 synchronization protocol or a precision time protocol (PTP).

20. The system of claim 17, wherein the wired network comprises a powerline communication (PLC) network configured according to IEEE 1901 standard.

21. The system of claim 17, wherein the WLAN comprises a WiFi network.

22. The system of claim 17, wherein the transmitted GNSS time is accurate to 100 nanoseconds or less.

23. The system of claim 17, wherein the transmitting is performed using an IEEE 1588 synchronization protocol or a precision time protocol (PTP).

24. A non-transitory computer-readable storage medium comprising code, which, when executed by a processor, causes the processor to perform operations for providing fine-time assistance (FTA) for a mobile device, the non-transitory computer-readable storage medium comprising:
code for receiving a GNSS time over a wired network from a GNSS receiver;
code for determining a round trip time (RTT) to the mobile device over a wireless local area network (WLAN); and
code for transmitting over the WLAN the GNSS time to the mobile device for calculating a FTA based GNSS time at the mobile device based on the transmitted GNSS time and the RTT.

25. A method of receiving fine-time assistance (FTA) at a mobile device, the method comprising:
determining a round trip time (RTT) between the mobile device and an access point (AP) over a wireless local area network (WLAN);
receiving a GNSS time from the AP over the WLAN; and
calculating a FTA based GNSS time at the mobile device based on the GNSS time from the AP and the RTT.

26. The method of claim 25, wherein the WLAN comprises a WiFi network.

27. The method of claim 25, further comprising receiving one or more signals from a first satellite, and computing a first pseudo-range measurement or first distance from the mobile device to the first satellite based at least in part on the FTA based GNSS time and the one or more signals.

28. The method of claim 27, further comprising receiving one or more signals from a second satellite and one or more signals from a third satellite,
determining a second and a third pseudo-range measurement from the mobile device to the second and third GNSS satellites based on the FTA based GNSS time and the one or more signals from the second satellite and third satellite; and
determining a location of the mobile device based on trilateration of the first, second, and third pseudo-range measurements.

29. The method of claim 25, wherein the FTA based GNSS time at the mobile device is accurate to 100 nanoseconds or less.

30. An apparatus for fine-time assistance (FTA) comprising:
logic configured to determine a round trip time (RTT) between a mobile device and an access point (AP) over a wireless local area network (WLAN);
a receiver configured to receive a GNSS time from the AP over the WLAN; and
logic configured to calculate a FTA based GNSS time at the mobile device based on the GNSS time from the AP and the RTT.

31. The apparatus of claim 30, wherein the WLAN comprises a WiFi network.

32. The apparatus of claim 30, further comprising a second receiver configured to receive one or more signals from a first satellite, and logic to compute a first pseudo-range measurement or first distance from the mobile device to the first satellite based at least in part on the FTA based GNSS time and the one or more signals.

33. The apparatus of claim 32, wherein the second receiver is further configured to receive one or more signals from a second satellite and one or more signals from a third satellite, the apparatus further comprising logic configured to:
determine a second and a third pseudo-range measurement from the mobile device to the second and third GNSS satellites based on the FTA based GNSS time and the one or more signals from the second satellite and third satellite; and
determine a location of the mobile device based on trilateration of the first, second, and third pseudo-range measurements.

34. The apparatus of claim 30, wherein the FTA based GNSS time at the mobile device is accurate to 100 nanoseconds or less.

35. A system comprising:
means for determining a round trip time (RTT) between a mobile device and an access point (AP) over a wireless local area network (WLAN);
means for receiving a GNSS time from the AP over the WLAN; and
means for calculating a fine-time assistance (FTA) based GNSS time based on the GNSS time from the AP and the RTT.

36. The system of claim 35, wherein the WLAN comprises a WiFi network.

37. The system of claim 35, further comprising means for receiving one or more signals from a first satellite, and means for computing a first pseudo-range measurement or first distance from the mobile device to the first satellite based at least in part on the FTA based GNSS time and the one or more signals.

38. The system of claim 37, further comprising means for receiving one or more signals from a second satellite and one or more signals from a third satellite,
means for determining a second and a third pseudo-range measurement from the mobile device to the second and third GNSS satellites based on the FTA based GNSS time and the one or more signals from the second satellite and third satellite; and
means for determining a location of the mobile device based on trilateration of the first, second, and third pseudo-range measurements.

39. The system of claim 35, wherein the FTA based GNSS time at the mobile device is accurate to 100 nanoseconds or less.

40. A non-transitory computer-readable storage medium comprising code, which, when executed by a processor, causes the processor to perform operations for providing fine-time assistance for a mobile device, the non-transitory computer-readable storage medium comprising:
code for determining a round trip time (RTT) between the mobile device and an access point (AP) over a wireless local area network (WLAN);
code for receiving a GNSS time from the AP over the WLAN; and
code for calculating a fine-time assistance (FTA) based GNSS time based on the GNSS time from the AP and the RTT.
